(19) United States
(12) Patent Application Publication
(10) Pub. No.: US 2008/0190489 A1
(43) Pub. Date: Aug. 14, 2008

(54) CHUCK FOR TIRE INFLATION VALVE

(75) Inventors: Daniel Wrubel, Grandville, MI (US); Fu Xinlong, Ningbo (CN)

Correspondence Address: VAN DYKE, GARDNER, LINN & BURKHART, LLP, SUITE 207, 2851 CHARLEVOIX DRIVE, S.E., GRAND RAPIDS, MI, 49546, US

(73) Assignee: EQAIR, LLC, Grandville, MI (US)

(21) Appl. No.: 11/779,643

(22) Filed: Jul. 18, 2007

Related U.S. Application Data
(60) Provisional application No. 60/889,593, filed on Feb. 13, 2007.

(51) Int. Cl. F16K 15/20; F16L 37/00

(52) U.S. Cl. 137/231; 251/149.1

(57) ABSTRACT

A chuck for connecting a pressure device to a valve stem of a pressurized vessel includes a body portion having a first passageway that is configured to receive an outer tube portion of a valve stem of a pressurized vessel therein. The body portion has a guide portion at an inner end of the first passageway. A pin element is movably disposed within a second passageway of the body portion and is movable along the coaxial passageways. The pin element extends longitudinally from the guide portion and toward an engaging end of the body portion. The guide portion includes an alignment element at least partially around the second passageway and extending longitudinally toward the engaging end of the body portion and at least partially around the pin element for engaging and supporting an interior portion of the end of the outer tube portion of the valve stem.

### CROSS REFERENCE TO RELATED APPLICATIONS

The present application claims the benefit of U.S. provisional application Ser. No. 60/889,593, filed Feb. 13, 2007, which is hereby incorporated herein by reference in its entirety.

### FIELD OF THE INVENTION

The present invention relates generally to chucks for attaching to and sealing at Schrader valves or the like for inflating tires or for checking or determining the air pressure (or gas or fluid pressure) in the tires of a vehicle.

### BACKGROUND OF THE INVENTION

Tire pressure gauges and tire inflation devices typically have a chuck for attaching to and substantially sealing at a Schrader valve of a tire (or other inflatable article). In order to properly inflate the article or to make an accurate pressure reading, the chuck must seal at the valve and limit or preclude leakage of air (or gas) at the chuck-valve connection. Often, such a seal is not readily made with conventional chucks and such leakage occurs, often leading to improperly inflated tires or articles.

### SUMMARY OF THE INVENTION

The present invention provides a chuck for sealing at a Schrader valve of a tire or other inflatable article and providing fluid communication between the tire or article and a pressure supply source attached to the chuck or a pressure gauge attached to the chuck.

According to an aspect of the present invention, a chuck for connecting a pressure device to a valve stem of a pressurized vessel includes a body portion and a pin element. The valve stem comprises an outer tube portion and a valve opening element movably disposed within the tube portion and movable to open the valve for inflation and deflation of the vessel. The body portion has an engaging end having a first passageway therethrough that is configured to receive the outer tube portion of the valve stem of the pressurized vessel therein. The body portion has a guide portion at an inner end of the engaging end. The guide portion has a second passageway therethrough, with the first passageway having a larger diameter than the second passageway and the first and second passageways being co-axial. The pin element is movably disposed within the body portion and movable along the first and second passageways. The pin element is configured to engage the valve opening element of the valve stem when the chuck is attached to the valve stem. The pin element extends longitudinally toward the engaging end of the body portion and extends from the guide portion of the body portion. The guide portion of the body portion comprises an alignment element at least partially around the second passageway and extending longitudinally toward the engaging end of the body portion and at least partially around the pin element. The alignment element is configured to engage an interior portion of the end of the outer tube portion of the valve stem to substantially align and support the valve stem within the body portion. Thus, the pin element may be substantially aligned with the valve opening element of the valve when the outer tube portion of the valve is received within the first passageway of the body portion.

The chuck may include a valve sealing gasket, such as a silicone O-ring or the like, at the guide portion and around the alignment element for sealingly engaging the end of the outer tube of the valve stem when the valve stem is received in the first passageway. Optionally, and desirably, the first passageway has a diameter that is slightly larger than the outer tube of the valve stem so that the valve is snugly received in the first passageway during use of the chuck. Optionally, in one form, the body portion may comprise a unitary body, with the guide portion and the alignment element being integrally formed with the body. In another form, the body portion may be formed separately from the guide portion and the alignment element.

The chuck preferably further includes a locking device for engaging the outer tube of the valve stem and substantially securing the outer tube within the first passageway when he valve stem is received within the first passageway and the locking device is in a locking position. The locking device may include a locking tooth that engages an outer surface of the outer tube when the locking device is in the locking position, with the locking tooth being movable in a direction generally transverse to the longitudinal axes of the passageways between the locking position and a release position, where the locking tooth is disengaged from the outer tube of the valve stem. Preferably, the locking tooth has an arcuate engaging surface that is formed to generally correspond to the outer surface of the cylindrical outer tube of the valve stem. The locking tooth may be located at or near an end of the pin element when the pin element is moved toward the engaging end.

Optionally, and desirably, the pin element includes a rear sealing portion that is movably received within a third passageway of the body portion, with the third passageway being coaxial with the second passageway and at an opposite side of the guide portion from the first passageway. The pin element is biased toward the engaging end of the chuck, whereby the rear sealing portion engages the guide portion or a chuck sealing gasket at the guide portion to limit movement of the pin element toward the engaging end and to substantially seal the pin element at the guide portion. The third passageway may receive a connector element for connecting the chuck to a pressure device.

The chuck preferably includes an inlet port for connecting to a pressure device, such as a pressurized air (or gas) supply hose, whereby the pressurized air or gas flows through the chuck and into the pressurized vessel when the chuck is connected to the valve of the pressurized vessel, or a pressure gauge, whereby the pressure gauge determines the pressure in the pressurized vessel when the chuck is attached to the valve of the pressurized vessel.

These and other objects, advantages, purposes and features of the present invention will become apparent upon review of the following specification in conjunction with the drawings.

### BRIEF DESCRIPTION OF THE DRAWINGS

FIG. 1 is a perspective view of a chuck for sealing at a valve of an inflatable article in accordance with the present invention, shown with the chuck in a locked position;

FIG. 2 is another perspective view of the chuck of FIG. 1, shown with the chuck in an unlocked position;

FIG. 3 is an exploded perspective view of the chuck of FIGS. 1 and 2;

FIG. 4 is a side elevation of the chuck of FIGS. 1 and 2;

FIG. 5 is an end elevation of the chuck of FIGS. 1 and 2;

FIG. 6 is a top plan view of the chuck of FIGS. 1 and 2;

FIG. 7 is a sectional view of the chuck taken along the line VII-VII in FIG. 5;

FIG. 8 is a sectional view of the chuck similar to FIG. 7, with a Schrader valve shown inserted into the chuck;

FIG. 9 is a sectional view similar to FIG. 8, showing another chuck receiving a Schrader valve in accordance with the present invention; and

FIG. 10 is an exploded perspective view of another chuck for sealing at a valve in accordance with the present invention.

### DESCRIPTION OF THE PREFERRED EMBODIMENTS

Referring now to the drawings and the illustrative embodiments depicted therein, a chuck 10 for a pressure device, such as a pressure source or pressure indicating device or gauge or the like, includes a housing or casing or body 12 and a locking device or element 14 for securing the chuck at a valve of a pressurized vessel, such as a tire inflation valve, such as a Schrader valve or the like. Chuck 10 further includes a pin engaging element or valve opening element or pin element 16 movably disposed within body 12 and movable relative to body 12 to engage a valve opening pin of a Schrader valve or the like when the outer tube of the valve is received within the body 12 of chuck 10, as discussed below. The pin element 16 is moved between a non-use position, where the pin element is moved toward a front or valve engaging end 12a of body 12, and a use position, where the pin element is moved back toward a rear or connecting end 12b of body 12 (such as in response to engagement of the pin element with a valve stem core or pin during use of chuck 10).

As best shown in FIGS. 4 and 7, body 12 comprises a generally hollow body with a passageway 18 formed longitudinally therethrough. In the illustrated embodiment, the passageway comprises three coaxial passageway portions: (i) a first or valve receiving passageway portion 18a that is open at the valve engaging end 12a of body 12, (ii) a second or guide passageway portion 18b at a generally central region of body 12, and (iii) a third larger diameter passageway portion 18c at or open at the connecting end 12b of body 12, all of which are coaxially formed within and through body 12. Body 12 may comprise a unitarily formed body (such as a body formed of a brass material or other suitable material) with the passageways formed therethrough.

First or valve receiving passageway portion 18a is a cylindrical passageway that is formed to substantially snugly receive the cylindrical outer tube portion of a valve therein, as shown in FIG. 8. Preferably, the diameter of valve receiving passageway 18a is only slightly larger than the outside diameter of the tube portion of the valve such that there is a relatively tight interference fit between body 12 and the outer surface of the tube portion when the valve stem is received in valve receiving passageway 18a, as discussed below. For example, the diameter of valve receiving passageway 18a may be about 7.9 mm or thereabouts to snugly receive a conventional valve stem.

A guide portion 20 of body 12 is formed in a generally central region of the body 12 and has second or guide passageway 18b formed therethrough, whereby guide portion 20 provides or defines the ends or inner walls of the first and third passageways 18a, 18c of body 12. Guide passageway 18b receives a longitudinal pin portion 16a of pin element 16 therein to guide and support the pin element as the pin element moves along the passageways during use of the chuck. Guide passageway 18b may have a diameter of about 3.6 mm or thereabouts, and pin portion 16a may have an outer diameter of about 3.5 mm or thereabouts, so that the pin portion 16a may substantially freely move through guide passageway 18b.

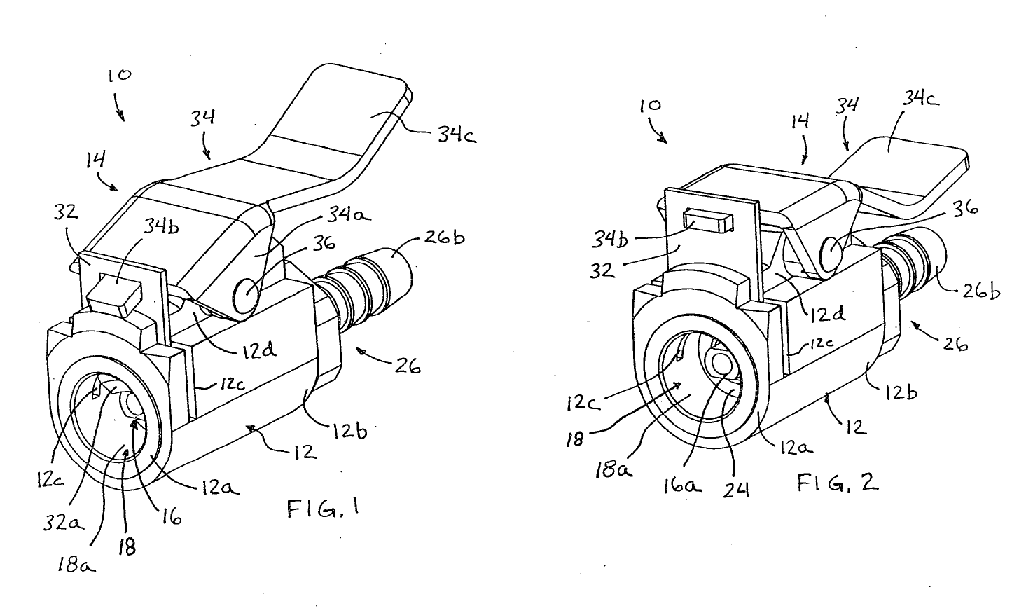

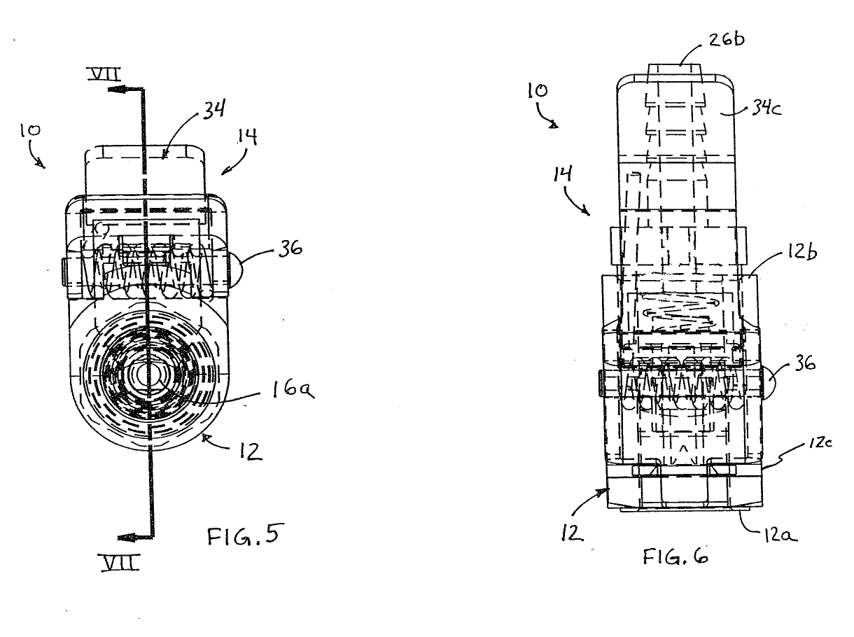

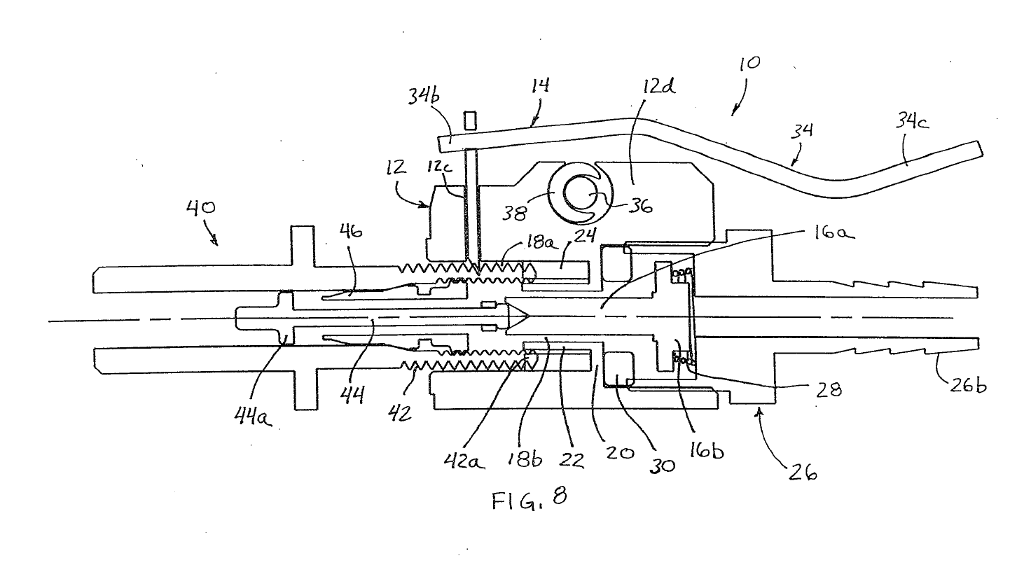

Guide portion 20 includes a valve alignment or valve centering guide element or centering sleeve 22, which is provided at the forward side of the guide portion 20 and at least partially around the passageway 18b and the pin element 16 and within passageway 18a. The valve centering guide element 22 thus extends into passageway 18a and is configured to be received within the outer tube portion of the valve stem when the valve is received in first passageway 18a, so as to substantially align and center the valve stem within passageway 18a during use of chuck 10, as discussed below. The valve centering guide element 22 may comprise a cylindrical extension from body portion 20 that is circumferentially around the passageway 18b, or may comprise a partial cylinder or multiple protrusions generally or at least partially around passageway 18b so as to at least partially engage and support the valve stem. In the illustrated embodiment of FIGS. 1-8, the valve centering guide element 22 and guide portion 20 are integrally formed with body 12 so that body 12 comprises a unitary body. However, the body element and/or guide element and/or guide portion may comprise separate elements, such as discussed below, while remaining within the spirit and scope of the present invention.

In the illustrated embodiment, a sealing element or gasket 24, such as a silicone gasket or O-ring or sleeve or the like, is disposed at the inner end of passageway 18a and around guide element 22. Sealing gasket 24 may have an outer diameter of about 7.9 mm and an inner diameter of about 5.4 mm so as to fit at the end of passageway 18a and at the forward end of guide portion 20 and around valve centering guide element 22. In the illustrated embodiment, sealing gasket 24 is similar in length (such as about 4.7 mm to about 4.8 mm or thereabouts) as an axial length of centering guide element 22 when sealing gasket 24 is in its non-compressed state. Sealing gasket 24 engages the end of the valve when the valve stem is received in valve receiving passageway 18a, so as to substantially seal against the valve stem and limit air leakage from within the valve (and thus from the inflatable vessel) during use of chuck 10, such as during inflation of the vessel or during a pressure check of the vessel.

Pin element 16 comprises longitudinal pin portion 16a and a wider diameter rear or sealing portion 16b. Pin portion 16a is received through passageway 18b and extends from passageway 18b and valve centering guide element 22 and toward the front or engaging end 12a of body 12. The larger diameter sealing portion 16a of pin element 16 is movably received within the third or larger diameter passageway 18c at the rearward end 12b of body 12 of the chuck 10. Sealing portion 16b may have an outside diameter of about 7.9 mm or thereabouts, which may substantially freely move within the passageway 18c.

As shown in FIG. 7, the third or rearward passageway 18c may receive a connecting element 26, which is received at least partially within passageway 18c (such as via a press fit engagement or threaded engagement or other substantially secure engagement), and is configured to connect to a pressure device, such as a hose of a pressurized air supply or gas supply source or a pressure gauge or the like. Connecting element 26 provides a hollow passageway therethrough to provide fluid communication between the pressure device and passageway 18 of chuck 10. As shown in FIG. 7, a forward end 26a of connecting element 26 provides a channel or passageway for receiving sealing portion 16b of pin element 16. In the illustrated embodiment, connecting element 26 includes a connecting end 26b that is configured to be received in a hose and secured relative thereto (such as a barbed fitting for inserting into an end of a hose or tube or conduit and functioning to limit retraction of the connecting end 26b from the hose or tube or conduit), but other connection means, such as a pipe fitting or the like, may be implemented without affecting the scope of the present invention. The connecting element may connect to a hose or conduit or port of an inflation device, such as a pressurized air or gas or fluid source, or may connect to a hose or conduit or port of a pressure gauge or the like, such as a pressure gauge of the types described in U.S. Des. Pat. No. D525,157 and/or U.S. patent application Ser. No. 11/355,821, filed Feb. 16, 2006 by Wrubel, which are hereby incorporated herein by reference in their entireties.

Connecting element 26 may include a biasing element 28 (such as a coil spring or the like) that engages sealing portion 16b of pin element 16 to bias the pin element toward the engaging end 12a of body 12 (and to bias or urge the larger diameter sealing portion 16b of pin element 16 toward guide portion 20 of body 12). A sealing element or gasket 30 is disposed at the inner end of the third passageway and at or against the rear wall of guide portion 20 of body 12, so that sealing portion 16b of pin element 16 is urged toward sealing element 30 by biasing element or spring 28 and engages sealing element 30 and substantially seals relative thereto so as to limit or substantially preclude air or gas leakage around the sealing element portion 16b when the pin element 16 is extended to its non-use position, such as when the chuck is not connected to a valve stem of a pressurized vessel. The gasket 30 may have an outside diameter of about 10.2 mm and an inside diameter of about 5.1 mm or other dimensions as desired or as dictated by the particular application of chuck 10.

As can be seen in FIG. 7, the outer or forward end of the pin portion 16a of pin element 16 extends substantially into the first or valve receiving passageway 18a, such that the end of the pin portion 16a (which may have a recess formed therein for receiving or engaging a pin of the valve) extends approximately half the distance or length of the first or receiving passageway 18a when in its extended or non-use position. As best shown in FIGS. 4 and 7, the end of the pin portion 16a is generally aligned with an engaging or locking tooth 32 of locking device 14 that engages the outer tube of the valve that is received within the passageway 18a to substantially secure chuck 10 onto the valve of the pressurized vessel.

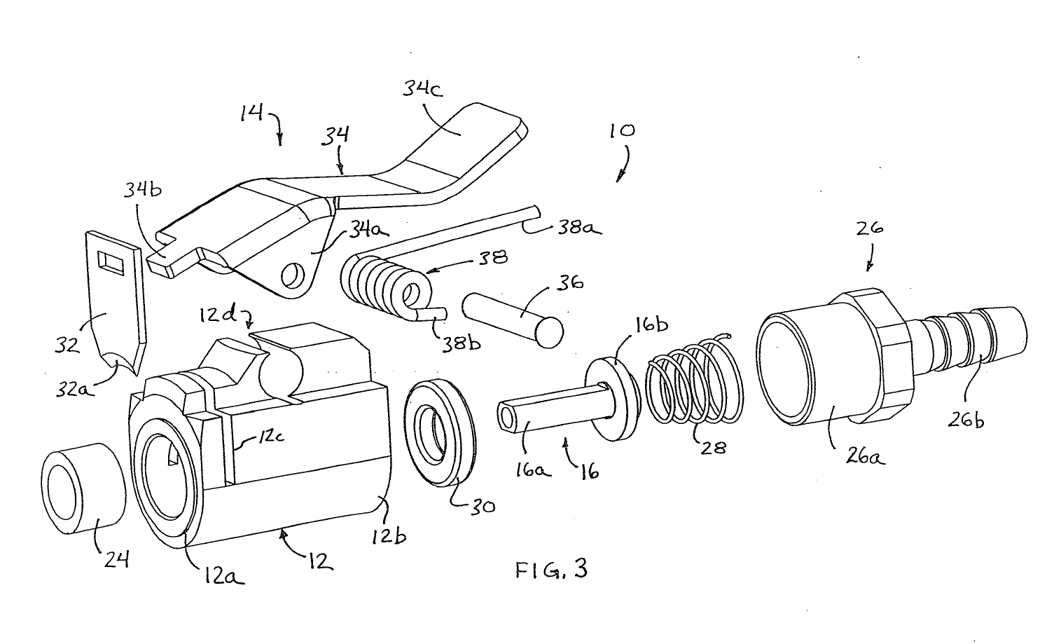

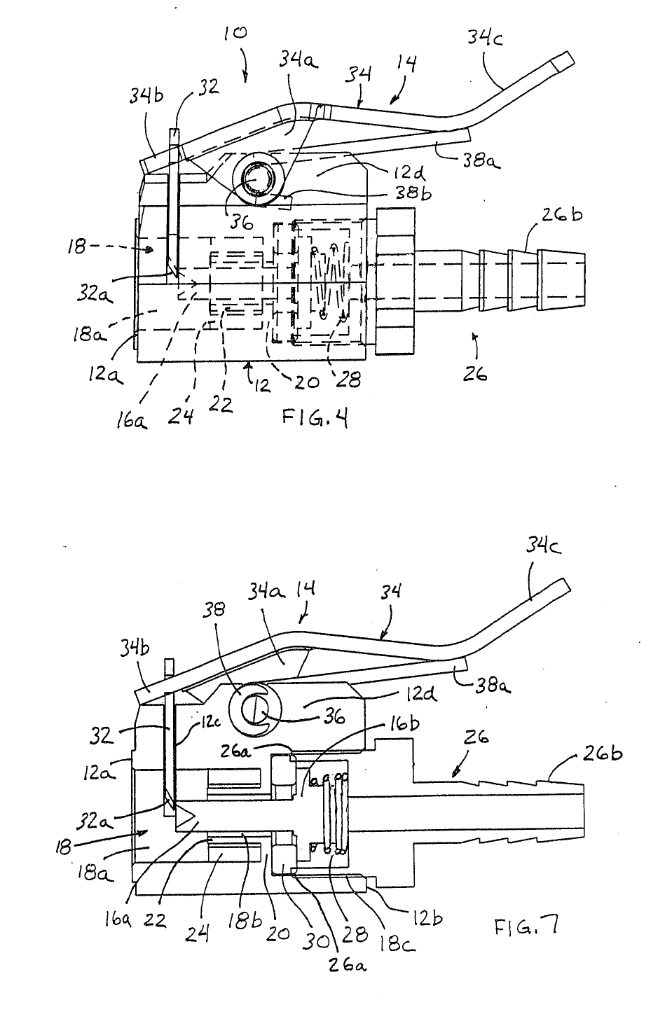

In the illustrated embodiment, locking tooth 32 is movable through a slot 12c formed in body 12 and in a direction that is generally transverse to the longitudinal axis of the pin element 16 and valve receiving passageway 18a via a lever or handle 34 that is pivotally mounted to body 12 via a pivot pin or axle 36 (which may pivotally mount the handle to the body via insertion of the pin 36 through mounting flanges 34a of handle 34 and through a cylindrical boss or mounting portion 12d of body 12). An end or tab 34b of the lever 34 extends through an opening or aperture formed at an upper or outer end of locking tooth 32, whereby pivotal movement of handle or lever 34 imparts a generally translational movement of locking tooth 32. Preferably, handle 34 and locking tooth 32 are biased or urged toward the engaged or locking position (such as shown in FIG. 1) via a biasing element 38, such as a torsional spring as shown in FIGS. 3 and 4. The biasing element or torsional spring 38 acts against a rear end region 34c of handle or lever 34 (such as via a handle acting end 38a of spring 38) and the body portion 12 (such as via a body acting end 38b of spring 38), so as to urge the rear end region 34c of lever 34 away from body 12 and thus to urge the tab 34b and tooth 32 toward the locking position. Thus, the handle 34 is urged toward the locking position shown in FIG. 1, which urges or biases the locking tooth 32 toward its engaging or locking position.

When it is desired to release the chuck 10 from the valve stem, the rear end 34c of handle 34 may be squeezed toward the body portion, whereby the handle will pivot about the pivot pin 36 and raise or pull the locking tooth 32 in a direction generally away from the valve stem within the passageway 18a, so as to release the valve stem and allow the valve stem to be retracted from the passageway 18a. As can be seen in FIGS. 1 and 3, the engaging end 32a of the locking tooth 32 comprises an arcuate end that is beveled to a relatively sharp edge for engaging and biting into the valve stem. The arcuate form of the engaging end 32a of the locking tooth 32 may be selected depending on the curve of the outer surface of the valve stem that is to be received in valve receiving passageway 18a, so that the locking tooth 32 substantially uniformly engages at least a portion of the outer surface of the valve stem when the valve stem is received within passageway 18a and the handle 34 is released. For example, the arcuate engaging end 32a of locking tooth 32 may be formed with its edge at a radius of curvature of about 5.9 mm or thereabouts, or may be more or less depending on the radius of the valve stem of the intended application of chuck 10. The locking tooth 32 may comprise any suitable material, and preferably comprises a strong and durable metallic material such as steel.

Referring now to FIG. 8, chuck 10 is shown as attached or connected to a valve 40 (such as a Schrader valve). As can be seen in FIG. 8, a valve stem or tube 42 (which may be a threaded tube for receiving a cap thereon such as is known in the valve stem art) is received in valve receiving passageway 18a of chuck 10 and is inserted into passageway 18a until an outer end 42a of valve stem 42 engages valve sealing gasket 24 at the inner or rear end of passageway 18a. When the valve stem 42 is so inserted, valve centering guide element 22 is at least partially received within the outer end 42a of valve stem 42 to guide and support the valve stem at the inner end of passageway 18a. Thus, the valve stem 42 is supported and substantially centered within passageway 18a, and when locking tooth 32 is biased or urged into biting or clamping engagement with valve stem 42, the force applied by the locking tooth 32 against the valve stem 42 does not move the valve stem 42 or misalign the valve stem 42 within the passageway 18a.

As can be seen in FIG. 8, when the valve stem 42 is received in valve receiving passageway 18a, the pin portion 16a of pin element 16 engages a valve stem core 44 and pushes or urges or moves the valve stem core 44 into the valve stem 42 to disengage a sealing portion 44a of valve stem core 44 from a sealing element 46 of the valve 40 within valve stem 42, so as to allow air to flow through the valve 40 (and such as in a known manner). When the valve stem core 44 is depressed by pin portion 16a, further movement of or insertion of valve stem 42 into chuck 10 urges pin element 16 rearwardly and depresses or compresses biasing element or coil spring 28 at the connecting element 26, whereby sealing portion 16b of pin element 16 is disengaged from chuck sealing gasket 30 to allow for air flow through chuck 10 and thus between the pressure device and the pressurized vessel.

When it is desired to disengage or disconnect the chuck 10 from the valve stem 42, the user may squeeze or pivot the handle 34 to move locking tooth 32 away from valve stem 42, whereby valve stem 42 may be retracted from the valve receiving passageway 18a of body 12 of chuck 10. As the valve stem 42 is moved outward from passageway 18a, pin element 16 is urged toward the engaging end 12a of body 12 (via biasing element or coil spring 28) until sealing portion 16b of pin element 16 engages and seals against sealing gasket 30 at the rear end of the guide portion 20 of body 12, so that air flow through chuck 10 is limited or stopped.

Thus, the present invention provides a normally closed chuck for attaching to a Schrader valve of a pressurized vessel, such as of a vehicle tire or the like. The pin element 16 is biased toward its closed position via the biasing element 28, so that air from a pressurized air supply source connected to connecting element 26 will not flow through the chuck 10 unless pin 16 in chuck 10 is depressed by the valve stem core 44 when the chuck 10 is attached to the valve stem 42. Thus, the rearward gasket 30 functions to seal the chuck 10 and prevent air flow through the chuck from the pressurized air source when the chuck and pressurized air source is not in use. When the chuck is pressed onto a valve stem, the valve stem core or pin pushes against pin element 16 to disengage the larger diameter sealing portion 16b from the gasket 30 to allow air flow through the chuck and into the pressurized vessel (or in the other direction for deflating the vessel if desired). When the valve stem is fully seated within the chuck, the forward gasket 24 seals against the valve stem and prevents air leakage during use of the chuck. The dual gasket chuck of the present invention thus provides a central guide portion of the body of the chuck with a seal or gasket at either side for sealing the chuck when the chuck is in use (and connected to a valve) and when the chuck is not in use (and disconnected from the valve).

The pin element 16 has a length dimension that allows the pin element to extend through the guide portion of the body and allows for substantial extension of the pin element into the valve receiving passageway 18a to engage with the valve stem core and maintain alignment with valve stem core as the valve stem core is received within passageway 18a. The substantial length of the pin element thus provides for accurate placement of the chuck against the valve stem core and against the valve stem when it is desired to inflate the pressurized vessel. Preferably, the pin element extends substantially along and through passageway 18a, so that the pin element 16 engages the valve stem core early on in the insertion process. Preferably, the locking tooth 32 is located generally at the end of the pin element 16 when the pin element is in its non-use or extended position, so that the locking tooth will not contact the pin element when the chuck is not in use, and is close to the inner end of the valve receiving passageway so that the locking tooth does not cause misalignment of the valve stem core with the pin element 16.

The chuck of the present invention thus provides a snug or substantially tight or firm engagement between the valve stem and the chuck body, and functions to align the pin element 16 with the valve stem core during the insertion process. The centering guide element engages and aligns and supports the valve stem when the valve stem is received in the chuck to support and retain the valve stem in position when the locking tooth is urged into engagement with the outer surface of the valve stem. The chuck of the present invention thus substantially locks the valve stem within the body portion of the chuck when the valve stem is fully inserted therein. The chuck of the present invention substantially seals to the valve stem and allows the chuck to be used on valves with pressures of up to about 200 p.s.i. or more without the chuck unintentionally or accidentally releasing from the valve stem, such that the present invention limits or substantially precludes accidental dislodging of the chuck from the valve stem. Also, the chuck of the present invention provides substantially reduces air leakage and limits or substantially precludes air leakage from the chuck that may otherwise result from hose movement at the connecting element 26 when the chuck is attached to a valve stem.

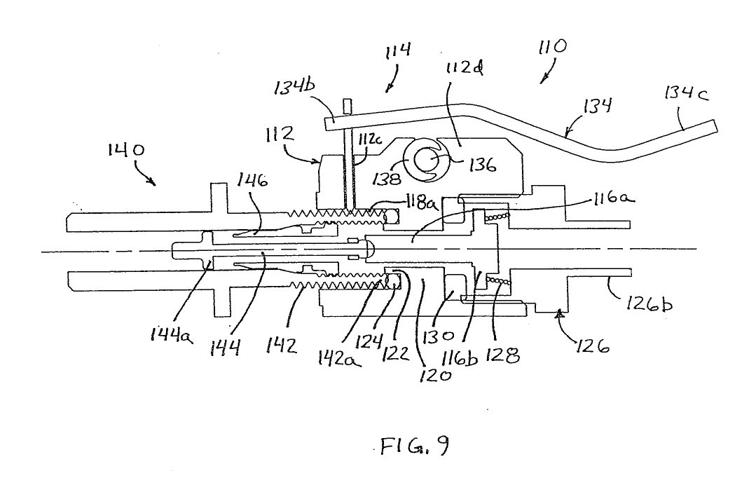

The dimensions provided for the chuck of the present invention are provided as exemplary dimensions and are not intended to limit the invention to the particular dimensions provided. For example, and with reference to FIG. 9, a chuck 110 may have a larger or longer guide portion 120 of body 112 and a shorter centering guide element 122 and sealing gasket or O-ring 124, whereby the valve stem 142 may be inserted further into passageway 118a until the end 142a of valve stem 142 engages and is supported by centering guide element 122. In the illustrated embodiment, sealing element or gasket 124, such as a silicone gasket or O-ring or the like, is disposed at the inner end of passageway 118a and around guide element 122 and may have an outer diameter of about 7.9 mm and an inner diameter of about 4.9 mm and a length of about 1.5 mm (and may be similar in length as the centering guide element 122) so as to fit at the end of passageway 118a and at the forward end of guide portion 120 and around valve centering guide element 122. In the embodiment of FIG. 9, the guide portion 120 is longer or larger (such as about 4.5 mm along the axis of body 112) than the guide portion 20 of body 12 (which may be about 1 mm or thereabouts along the axis of body 12 of chuck 10). Chuck 110 may otherwise be substantially similar to chuck 10, discussed above, such that a detailed discussion of the chucks need not be repeated herein. The similar or common components or elements or features of the chucks are shown in FIG. 9 with similar reference numbers as used in FIGS. 1-8, but with 100 added thereto. Other dimensioned features or elements or components may be implemented in a chuck, while remaining within the spirit and scope of the present invention.

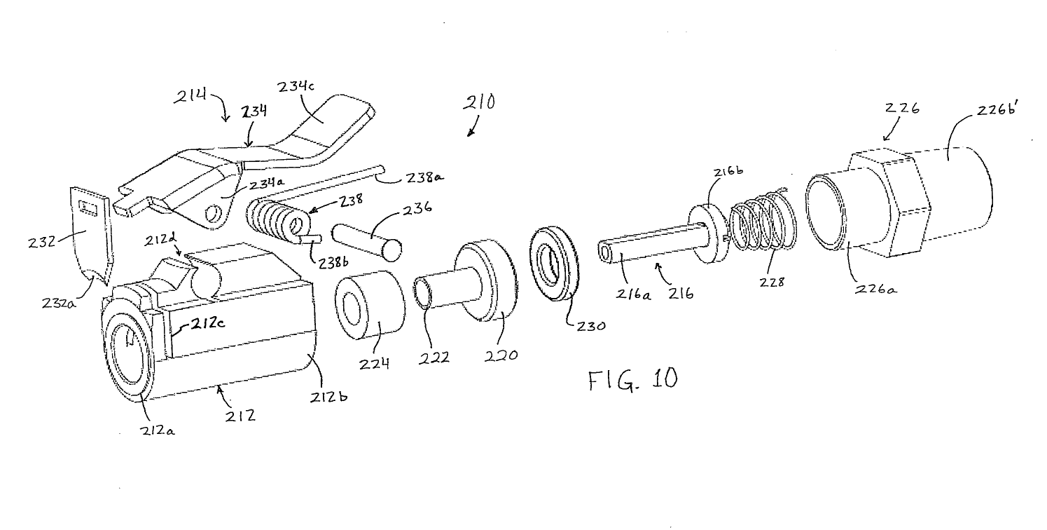

Although shown and described as having a valve centering guide element and guide portion integrally formed with the body, it is envisioned that the guide portion and/or guide element may comprise separate components or elements that are attached to the body. For example, and as shown in FIG. 10, a separate element comprising a guide portion 220 and a guide element 222 may be provided in a chuck 210, where guide portion 220 and guide element 222 are received in a passageway in a body 212 of chuck 210, such as in a similar manner as described above. Guide portion 220 may be attached to or secured at body 212, such as, for example, by threadably engaging body 212. The connecting end 226b of chuck 2110 may provide any suitable connecting element or connecting means for connecting the chuck to a pressurized gas or air supply. For example, and as shown in FIG. 10, the connecting end 226b of chuck 210 may comprise a pipe fitting or the like for attaching or connecting to a pipe or end piece of a pressurized air or gas supply, such as to a pipe or end piece at an end of a pipe or hose or the like. Chuck 210 may otherwise be substantially similar to chuck 10, discussed above, such that a detailed discussion of the chucks need not be repeated herein. The similar or common components or elements or features of the chucks are shown in FIG. 10 with similar reference numbers as used in FIGS. 1-8, but with 200 added thereto.

Although described above as being connectable to a pressurized air source for pressurizing tires of a vehicle via air flow through the chuck, clearly the chuck may be connected to other pressure devices or pressurized sources, such as a pressurized nitrogen source or other suitable gas or fluid, without affecting the scope of the present invention. Such pressurized sources of nitrogen may be desired in some applications, due to the reduced affect a change in temperature has on nitrogen (whereby the pressure in the tires may remain substantially constant even when there is a significant change in temperature at or in the tires). It is clear that the chuck of the present invention (and associated pressure source or pressure gauge or the like) may be used in connection with any suitable medium, such as air or gas or fluid or the like, while remaining within the spirit and scope of the present invention. The term “air” as used herein thus is not intended to limit the scope of the present invention to chucks for pressure gauges or pressure sources for use with pressurized air only, but rather is intended to mean any air or gas or fluid medium or composition that may be used to pressurize tires or inner tubes or other inflatable/deflatable articles or vessels or the like.

Changes and modifications to the specifically described embodiments may be carried out without departing from the principles of the present invention, which is intended to be limited only by the scope of the appended claims as interpreted according to the principles of patent law including the doctrine of equivalents.

1. A chuck for connecting a pressure device to a valve stem of a pressurized vessel, the valve stem comprising an outer tube portion and a valve opening element movably disposed within the tube portion and movable to open the valve for inflation and deflation of the vessel, said chuck comprising:
a body portion having an engaging end, said engaging end having a first passageway therethrough that is configured to receive the outer tube portion of the valve stem of a pressurized vessel therein;
said body portion having a guide portion at an inner end of said engaging end, said guide portion having a second passageway therethrough, said first passageway having a larger diameter than said second passageway and said first and second passageways being co-axial;
a pin element movably disposed within said body portion and movable along said first and second passageways, said pin element being configured to engage the valve opening element of the valve stem when said chuck is attached to the valve stem;
said pin element extending longitudinally toward said engaging end of said body portion and extending from said guide portion of said body portion; and
wherein said guide portion comprises an alignment element at least partially around said second passageway and extending longitudinally toward said engaging end of said body portion and at least partially around said pin element, said alignment element being configured to engage an interior portion of the end of the outer tube portion of the valve stem to substantially align and support the valve stein within said body portion so that said pin element is substantially aligned with the valve opening element of the valve when the outer tube portion of the valve is received within said first passageway of said body portion.

2. The chuck of claim 1 further comprising a valve sealing gasket at said guide portion for sealingly engaging the end of the outer tube of the valve stem when the valve stem is received in said first passageway.

3. The chuck of claim 2, wherein said valve sealing gasket comprises a silicone material.

4. The chuck of claim 2, wherein said valve sealing gasket is disposed around said alignment element of said guide portion of said body portion.

5. The chuck of claim 1, wherein said first passageway has a diameter that is slightly larger than the outer tube of the valve stem so that the valve is snugly received in said first passageway during use of said chuck.

6. The chuck of claim 1, wherein said body portion comprises a unitary body, said guide portion and said alignment element being integrally formed with said unitary body.

7. The chuck of claim 1, wherein said alignment element comprises a substantially cylindrical element extending axially along said passageways and into said first passageway of said body portion.

8. The chuck of claim 1 further comprising a locking device for engaging the outer tube of the valve stem and substantially securing the outer tube within said first passageway when said valve stem is received within said first passageway and said locking device is in a locking position.

9. The chuck of claim 8, wherein said locking device comprises a locking tooth that engages an outer surface of the outer tube when said locking device is in said locking position, said locking tooth being movable in a direction generally transverse to the longitudinal axes of said passageways between said locking position and a release position, where said locking tooth is disengaged from the outer tube of the valve stem.

10. The chuck of claim 9, wherein said locking tooth is moved via pivotal movement of a handle pivotally mounted at an outer portion of said body portion, said handle being biased relative to said body portion so that said locking tooth is biased toward said locking position.

11. The chuck of claim 9, wherein said locking tooth has an arcuate engaging surface that is formed to generally correspond to the curved outer surface of a cylindrical outer tube of the valve stem.

12. The chuck of claim 9, wherein said locking tooth comprises a metallic material.

13. The chuck of claim 9, wherein said locking tooth is located at or near an end of said pin element when said pin element is moved toward said engaging end.

14. The chuck of claim 1, wherein said pin element includes a rear sealing portion that is movably received within a third passageway of said body portion, said third passageway being coaxial with said second passageway and at an opposite side of said guide portion from said first passageway.

15. The chuck of claim 14, wherein said pin element is biased toward said engaging end of said chuck, said rear sealing portion engaging said guide portion to limit movement of said pin element toward said engaging end.

16. The chuck of claim 15 further comprising a chuck sealing gasket at said guide portion for sealingly engaging said rear sealing portion of said pin element when said pin element is moved toward said engaging end.

17. The chuck of claim 15, wherein said third passageway receives a connector element for connecting said chuck to a pressure device.

18. The chuck of claim 1, wherein said guide portion is connected to said body portion adjacent said first passageway.

19. The chuck of claim 20, wherein said guide portion is threadably received at said body portion.

20. A chuck for connecting a pressure device to a valve stem of a pressurized vessel, the valve stem comprising an outer tube portion and a valve opening element movably disposed within the tube portion and movable to open the valve for inflation and deflation of the vessel, said chuck comprising:
a body portion having an engaging end, said engaging end having a first passageway therethrough that is configured to receive the outer tube portion of the valve stem of a pressurized vessel therein;
said body portion having a guide portion at an inner end of said engaging end, said guide portion having a second passageway therethrough, said first passageway having a larger diameter than said second passageway and said first and second passageways being co-axial;
a pin element movably disposed within said body portion and movable along said first and second passageways, said pin element being configured to engage the valve opening element of the valve stem when said chuck is attached to the valve stem;
said pin element extending longitudinally toward said engaging end of said body portion and extending from said guide portion of said body portion;
a valve sealing gasket at said guide portion for sealingly engaging the end of the outer tube of the valve stem when the valve stem is received in said first passageway;
a locking device for engaging the outer tube of the valve stem and substantially securing the outer tube within said first passageway when said valve stem is received within said first passageway and said locking device is in a locking position, said locking device comprising a locking tooth that engages an outer surface of the outer tube when said locking device is in said locking position, said locking tooth being movable in a direction generally transverse to the longitudinal axes of said passageways between said locking position and a release position, where said locking tooth is disengaged from the outer tube of the valve stem;
wherein said guide portion comprises an alignment element at least partially around said second passageway and extending longitudinally toward said engaging end of said body portion and at least partially around said pin element, said alignment element being configured to engage an interior portion of the end of the outer tube portion of the valve stem to substantially align and support the valve stem within said body portion so that said pin element is substantially aligned with the valve opening element of the valve when the outer tube portion of the valve is received within said first passageway of said body portion; and
wherein said pin element is biased toward said engaging end of said chuck, said pin element including a rear sealing portion that engages said guide portion when said pin element is moved toward said engaging end of said chuck to limit movement of said pin element toward said engaging end of said chuck.
